(19) United States
(12) Patent Application Publication
(10) Pub. No.: US 2025/0003861 A1
(43) Pub. Date: Jan. 2, 2025

(54) METHOD FOR EVALUATING THE CORROSION RESISTANCE OF A SURFACE

(71) Applicant: SAFRAN LANDING SYSTEMS, Velizy-Villacoublay (FR)

(72) Inventor: Alex Jacoboni, Moissy-Cramayel (FR)

(73) Assignee: SAFRAN LANDING SYSTEMS, Velizy-Villacoublay (FR)

(21) Appl. No.: 18/708,750

(22) PCT Filed: Nov. 15, 2022
(86) PCT No.: PCT/EP2022/081976

§ 371 Date: May 9, 2024

(30) Foreign Application Priority Data
Nov. 17, 2021 (FR) FR2112171

(51) Int. Cl. G01N 17/02

(52) U.S. Cl. CPC G01N 17/02

(57) ABSTRACT

Disclosed is a method for evaluating the corrosion resistance of at least one surface, comprising: •a) carrying out one or more sequences of n cyclical electrochemical test cycles on the surface, where n is an integer higher than or equal to 1, each cycle comprising the following three successive steps: •a first step of measurement, by electrochemical impedance spectroscopy, of one or more electrochemical quantities representative of the corrosion resistance of the surface; •a second step of cathodic polarization carried out at a voltage below −5 V, preferably comprised between −5 V and −10 V, and more preferably comprised between −7 V and −9 V; •a third step of potential relaxation; and•b) carrying out a visual inspection at the end of each cyclical electrochemical test sequence so as to detect a degradation of the surface, and, when the appearance of a degradation of the surface during a sequence is detected by visual inspection, stopping the cyclical electrochemical test cycles at the end of this sequence and *c) evaluating the corrosion resistance of the surface on the basis of the study of the measured electrochemical quantities.

### TECHNICAL FIELD

The present invention generally relates to the corrosion resistance of a surface.

More specifically, the invention relates to a method for evaluating the corrosion resistance of a surface, such as the surface of an aircraft part.

### PRIOR ART

In the aeronautical field, protection against corrosion of the constituent parts of an aircraft is a major concern in order to be able to guarantee their reliability and their longevity.

A plurality of corrosion protection means may be obtained by treating the surface of the aircraft part.

An existing solution consists in applying a coating at the surface of the part made of a material having corrosion resistance properties superior to the properties of the part receiving the coating. According to one example, it is possible to deposit a paint layer.

Conventionally, saline spray tests are carried out in order to discriminate different protection means according to their capacity to resist corrosion and to detect the best candidate according to the role and the location of the part in the aircraft.

A saline solution is vaporised at the surface of each of the materials to be evaluated under certain predefined pressure, pH and temperature conditions.

However, the method may require up to thousands of operating hours, in particular for surface treatments that are particularly resistant to corrosion such as some paints. Consequently, the implementation of salt spray tests is long and tedious.

### DISCLOSURE OF THE INVENTION

Hence, the invention aims to overcome these drawbacks and to provide a simple-to-implement method allowing rapidly evaluating the corrosion resistance of a surface.

Hence, a method for evaluating the corrosion resistance of at least one surface is provided, comprising:
a) carrying out one or more sequence(s) of n cyclic electrochemical test cycles on the surface, where n is an integer greater than or equal to 1, each cycle including the following three successive steps:
a first step of measuring by electrochemical impedance spectroscopy one or more electrochemical quantity/quantities reflecting the corrosion resistance of the surface;
a second cathodic polarisation step; and
a third potential relaxation step;
b) carrying out a visual inspection at the end of each cyclic electrochemical test sequence for the detection of a degradation of the surface and, upon detection, by visual inspection, of the apparition of a degradation of the surface during a sequence, the cyclic electrochemical test cycles being stopped at the end of said sequence; and
c) evaluating the corrosion resistance of the surface based on the study of the measured electrochemical quantities.

Other objects, features, aspects and advantages of the invention will appear even more clearly upon reading the description of the appended drawings wherein:

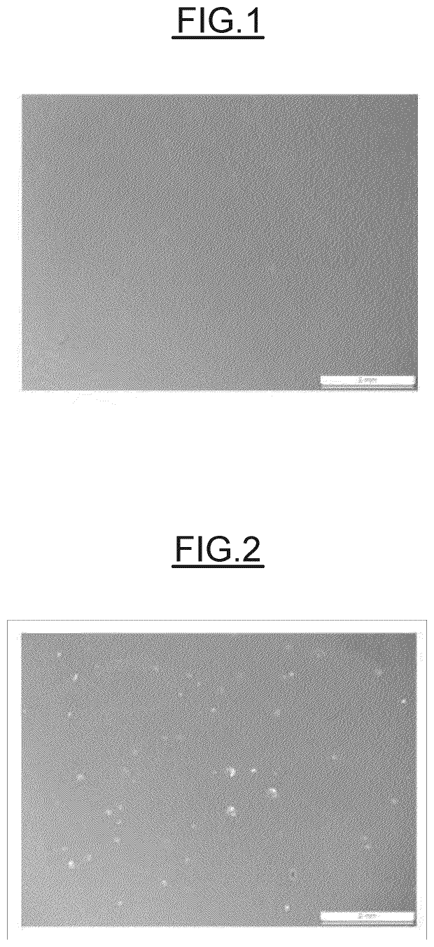

FIG. 1 is a photograph of a metal sample coated with a layer of non-chromated solvent-based paint A obtained upon completion of a method for evaluating the corrosion resistance according to the invention.

FIG. 2 is a photograph of a metal sample coated with a layer of chromated paint B obtained upon completion of a method for evaluating the corrosion resistance according to the invention.

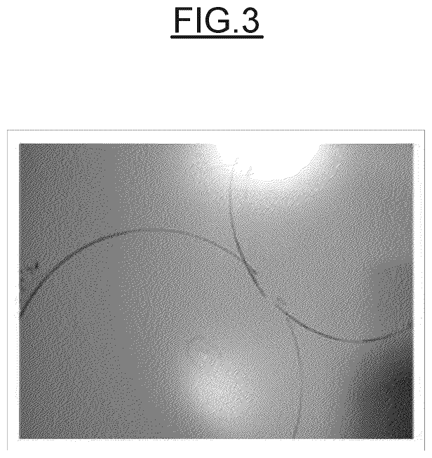

FIG. 3 is a photograph of a metal sample coated with a layer of non-chromated water-dilutable paint C obtained upon completion of a method for evaluating the corrosion resistance according to the invention.

Next, the bounds of a value interval are included in this interval, in particular in the expression “comprised between”.

Moreover, the expression “at least one” used in the present description is equivalent to the expression “one or more”.

For example, the surface whose corrosion resistance is evaluated may be the surface of an aircraft part.

We do not depart from the scope of the invention if the method relates to the evaluation of the corrosion resistance of a surface of a part of a different sector.

The studied surface may be the surface of a part having undergone a surface treatment.

According to one example, the studied surface is the surface of a coating applied over the part, such as a paint.

During a first phase of the method for evaluating the corrosion resistance of the surface, one or more sequence(s) of n cyclic electrochemical test cycles are carried out at the surface.

The cyclic electrochemical test is an accelerated cyclic electrochemical test or “ACET”, abbreviation of the English terms “Accelerated Cyclic Electrochemical Test”, also known as AC-DC-AC test method, is conventionally used to theoretically characterise the corrosion resistance properties of a coating.

Each cycle includes three successive steps.

The first step is a step of measuring by electrochemical impedance spectroscopy allowing characterising the surface by obtaining one or more electrochemical quantity/quantities from which it is possible to determine the corrosion resistance of the surface.

The measurements may be carried out using a potentiostat including an electrochemical impedance spectroscopy component.

Preferably, the first step of measuring by electrochemical impedance spectroscopy comprises establishing one or more graphical representation(s) from among: a phase diagram, an impedance modulus diagram and a Nyquist diagram.

The second step is a cathodic polarisation step, allowing cathodically loading the surface in order to degrade it.

Preferably, the cathodic polarisation step comprises monitoring the evolution of the intensity as a function of time by establishing a graphical representation.

The third potential relaxation step is a rest step which enables the surface to recover its equilibrium after loading.

Preferably, the potential relaxation step comprises monitoring the evolution of the abandon potential, also called open-circuit potential (OCP) as a function of time by establishing a graphical representation.

According to the invention, the accelerated cyclic electrochemical test (ACET) sequences, and in particular the interpretation of the data derived from the first step, are correlated with a visual inspection of the surface.

By visual inspection, it should be understood the detection of a degradation by an operator with the naked eye.

Indeed, a visual inspection is carried out at the end of each accelerated cyclic electrochemical test (ACET) sequence in order to detect a degradation of the surface.

Upon detection, by visual inspection, of the apparition of a degradation during a sequence, the accelerated cyclic electrochemical test cycles are stopped.

More specifically, the accelerated cyclic electrochemical test cycles are stopped at the end of the sequence during which the apparition of a degradation of the surface has been detected by visual inspection.

This correlation allows simplifying and optimising the characterisation of the corrosion resistance properties of a surface and defining them with greater accuracy.

Thus, the corrosion resistance of the surface is determined based on the study of the results obtained during the first accelerated cyclic electrochemical test step, i.e. based on the measured electrochemical quantities.

According to one embodiment, after detection of a degradation by visual inspection, it is possible to provide, during the last cycle of the last sequence, for a fourth step similar to the first step, for measuring by electrochemical impedance spectroscopy one or more electrochemical quantity/quantities reflecting the corrosion resistance of the surface.

Preferably, the method for evaluating the corrosion resistance of the surface comprises determining the cycle during which the degradation, noticed by visual inspection, has appeared. This determination is performed by study of the electrochemical quantities measured during the lastly completed sequence, i.e. before stoppage of the accelerated cyclic electrochemical test cycles.

Preferably, the determination of the cycle during which the degradation has appeared comprises the study of the established graphical representations, such as a phase diagram, an impedance modulus diagram and a Nyquist diagram.

Preferably, the second step of cathodic polarisation is carried out at a voltage lower than −5 V in order to create defects on the surface, preferably comprised between −5 V and −10 V, more preferably comprised between −7 V and −9 V.

In addition, the number n of cycles of an accelerated cyclic electrochemical test sequence may be comprised between 2 and 10, preferably comprised between 4 and 8, more preferably equal to 6.

The number n of cycles of a sequence could be adjusted according to the nature of the surface, for example the surface of a studied coating.

Preferably, the second step of cathodic polarisation may be carried out for a time period comprised between 10 min and 60 min, preferably comprised between 15 min and 25 min.

A duration comprised between 15 and 25 min is particularly advantageous for obtaining a visible degradation without being too severe.

Prior to the completion of the sequences of n accelerated cyclic electrochemical test cycles (ACET), a step of verifying the absence of defects of the surface could be performed in order to ensure that no defect is likely to distort the results of the evaluation of the corrosion resistance of the surface, in particular by formation of a preferential corrosion at this defect potential.

According to one embodiment, it is possible to provide for the evaluation of the corrosion resistance of a plurality of surfaces. The method for evaluating corrosion resistance could then comprise a step of comparing the corrosion resistance of a plurality of surfaces.

For example, the evaluation of the corrosion resistance of a plurality of surfaces could allow discriminating different coatings according to their capacity to resist corrosion and detecting the best candidate according to the role and the location of the coated part.

It is then possible to determine and classify the different surfaces according to their corrosion resistance. The different surfaces may be classified by considering the number of sequences of n cycles to which each of these surfaces resists.

According to one embodiment, as of the detection, by visual inspection, of the apparition of a degradation of one of the surfaces during a sequence, the accelerated cyclic electrochemical test cycles of the plurality of surfaces are stopped at the end of this sequence.

Advantageously, the different coatings have the same thickness.

Advantageously, prior to the completion of the sequences of n accelerated cyclic electrochemical test (ACET) cycles, the method for evaluating the corrosion resistance could comprise a step of verifying the evenness of the thicknesses of the different coatings.

According to one example, the levelling of the thicknesses of the different coatings may be performed by a method based on the eddy current principle.

### DETAILED DISCLOSURE OF ONE EMBODIMENT

### Example

Three samples of aircraft parts have been prepared from metal substrates made of 7050 aluminium alloy, coated, respectively, with a layer of non-chromated solvent-based paint A, a layer of chromated paint B and a layer of non-chromated water-dilutable paint C and the corrosion resistance of the three samples is studied using a method for evaluating the corrosion resistance according to an embodiment of the invention.

The corrosion resistance of these three coatings is evaluated from a three-electrode system including a reference electrode Ag/AgCl, a counter-electrode made of graphite, and a solution of NaCl electrolyte with a mass concentration comprised between 20 and 40 g·L⁻¹.

The studied surface of the coatings of the three samples exposed to the NaCl solution is 7.07 cm².

A sequence of six successive accelerated cyclic electrochemical test (ACET) cycles is carried out at the surface of the three samples.

Each cycle comprises first, second and third successive steps.

A first step of measuring electrochemical quantities comprising establishing, by electrochemical impedance spectroscopy, Bode diagrams, in particular the phase diagram and the impedance modulus diagram, and a Nyquist diagram.

The electrochemical impedance spectroscopy is performed for a time period t equal to 7 min and at a voltage equal to +10 mV vs OCP, where OCP is the open-circuit potential or abandon potential.

A second step of cathodic polarisation is performed for a time period comprised between 15 and 25 min and at a voltage comprised between −7 and −9 V vs OCP, allowing cathodically loading the surface in order to degrade it. A graphical representation of the intensity as a function of time is made.

A third potential relaxation step is performed. This rest step enables the surface to return to its equilibrium after having been highly loaded. A graphical representation of the evolution of the open-circuit potential as a function of time, over a total time period equal to 3 h, is made.

The number n of cycles per sequence is selected equal to 6.

At the end of each sequence of 6 cycles, a visual inspection of the surface is performed in order to detect the apparition of a degradation on the three coatings.

When a degradation of one of the surfaces is detected during a sequence, the accelerated cyclic electrochemical test (ACET) cycles of the three coatings are stopped at the end of this sequence.

The visual inspection has allowed noticing the apparition of a degradation during the first sequence of 6 cycles. A blister has appeared at the surface of the non-chromated water-dilutable paint C and a blistering and a stitching have appeared at the surface of the chromated paint B, as visible, respectively, in FIGS. 3 and 2.

No degradation has appeared at the surface of the non-chromated solvent-based paint A, as one could notice in FIG. 1.

The accelerated cyclic electrochemical test (ACET) cycles are then stopped at the end of this first sequence of 6 cycles.

Interpretation of the Results for the Electrochemical System with Paint with Non-Chromated Solvent-Based Paint a after 6 ACET Test Cycles

The phase diagram allows noticing the presence of a capacitive behaviour during the 6 cycles and the absence of degradation. The impedance modulus diagram allows noticing an overall high corrosion resistance of 10¹⁰ Ω·cm². This reflects a good corrosion resistance according to the graph.

The Nyquist diagram allows noticing a negligible decrease in the arcs of circles and an absence of degradation.

The graphical representation of the intensity as a function of time during the cathodic polarisation allows noticing a very low charge transfer of 10-9 A and therefore the absence of degradation.

The graphical representation of the abandon potential as a function of time during the potential relaxation allows noticing the obtainment of high potentials and the presence of small variations, reflecting the absence of degradation.

No degradation has appeared at the surface of the non-chromated solvent-based paint A and the study of the electrochemical cycles allows validating this visual observation.

All these interpretations lead to the conclusion that the non-chromated solvent-based paint 1 is an effective protective coating against corrosion, undergoing no degradation after a sequence of 6 ACET cycles.

Interpretation of the Results for the Electrochemical System with the Non-Chromated Water-Dilutable Paint C after 6 ACET Cycles

The phase diagram allows noticing the switch from a capacitive nature into a resistive nature during the 6 ACET test cycles, reflecting a degradation.

The impedance modulus diagram allows noticing an overall corrosion resistance that is high and which decreases over the 6 ACET test cycles, with a passage from 10¹⁰ Ω·cm² to 108 Ω·cm². This reflects a good corrosion resistance and a low or punctual degradation.

The Nyquist diagram allows observing a negligible decrease in arcs of circles, reflecting little or no degradations.

The graphical representation of the intensity as a function of time obtained during the cathodic polarisation allows noticing a very low charge transfer 10-7 A, which increases for the cycles 5 and 6 with intensities in the range of 10-4 A. This reflects a degradation over the cycles.

The graphical representation of the abandon potential as a function of time obtained during the potential relaxation allows noticing the obtainment of potentials equal to the corrosion potential of the aluminium alloy 7050. This reflects a risk of infiltration of the electrolyte up to the metal substrate which could lead to a degradation of the coating.

All these interpretations lead to the conclusion that, on the basis of the impedance modulus diagram, the non-chromated water-dilutable paint C generally has a good corrosion resistance. Nevertheless, on the basis of the graphical representations obtained during the cathodic polarisation, and of the potential relaxation during the ACET test cycles, a degradation seems to appear. Indeed, a blister has appeared at the surface of the non-chromated water-dilutable paint C and the study of the electrochemical cycles allows validating this visual observation.

Interpretation of the Results for the Electrochemical System with the Chromated Paint B after 6 ACET Cycles

The phase diagram allows noticing the switch from a capacitive nature into a resistive nature during the 6 cycles, and that being so in two times. This reflecting the apparition of a degradation.

The impedance modulus diagram allows noticing an overall resistance to corrosion that is initially high, but which decreases over the 6 cycles, with a passage from 109 Ω·cm² to 105 Ω·cm². This reflects a significant degradation of the system, 105 Ω·cm² being a low value for a paint.

The Nyquist diagram allows observing a significant decrease in arcs of circles reflecting a degradation.

The graphical representation of the intensity as a function of time obtained during the cathodic polarisation reflects a charge transfer which increases over the 6 ACET test cycles up to 40 mA. This high current indicates the apparition of corrosion phenomena.

The graphical representation of the abandon potential as a function of time obtained during the potential relaxation allows noticing the obtainment of potentials equal to the corrosion potential of the aluminium alloy 7050. This reflects a risk of infiltration of the electrolyte up to the metal substrate which could lead to a degradation of the coating.

Blistering and stitching have appeared at the surface of the chromated paint B and the study of the electrochemical cycles allows validating this visual observation.

All these interpretations lead to the conclusion that the chromated paint B coating may have defects after 6 ACET test cycles.

In conclusion, after 6 ACET test cycles, on the basis of the interpretations of the results, no degradation of the non-chromated solvent-based paint A, a localised degradation of the non-chromated water-dilutable paint C and a generalised degradation of the chromated paint B are expected. These interpretations made by the study of electrochemical cycles allow validating the visual observation of the surface of the samples.

Thus, it is possible to classify the three paints according to their corrosion resistance by studying the electrochemical measurements reported during the cycles correlated with the reported visual apparition of the surface of the three coatings.

1. A method for evaluating the corrosion resistance of at least one surface, the method comprising:
a) carrying out one or more sequences of n cyclic electrochemical test cycles on the at least one surface, wherein n is an integer greater than or equal to 1, and wherein each cycle of the n cyclic electrochemical test cycles includes the following three successive steps:
a first step of measuring by electrochemical impedance spectroscopy one or more electrochemical quantities reflecting the corrosion resistance of the surface;
a second step of cathodic polarisation carried out at a voltage between −5 V and −10 V; and
a third potential relaxation step;
b) carrying out a visual inspection at the end of each cyclic electrochemical test sequence for detecting a degradation of the surface and, upon detection, by visual inspection, of the apparition of a degradation of the surface during a sequence, the cyclic electrochemical test cycles being stopped at the end of said sequence; and
c) evaluating the corrosion resistance of the surface based on the measured electrochemical quantities.

2. The method according to claim 1, further comprising determining the cycle during which the degradation has appeared based on the electrochemical quantities measured during the lastly completed sequence.

3. The method according to claim 2, wherein the first step of measuring by electrochemical impedance spectroscopy comprises establishing one or more graphical representations from among: a phase diagram, an impedance modulus diagram and a Nyquist diagram.

4. The method according to claim 1, wherein the number n of cycles of a cyclic electrochemical test sequence is between 2 and 10.

5. The method according to claim 1, wherein the second step of cathodic polarisation is carried out for a time period between 10 min and 60 min.

6. The method according to claim 1, further comprising evaluating the corrosion resistance of the surface of at least one aircraft part.

7. The method according to claim 1, further comprising comparing the corrosion resistance among a plurality of surfaces.

8. The method according to claim 7, wherein upon detection, by visual inspection, of the apparition of a degradation of one of the surfaces during a sequence, the cyclic electrochemical test cycles of the plurality of surfaces being stopped at the end of said sequence.

9. The method according to claim 1, further comprising a step of verifying an absence of defects in the surface prior to the completion of the sequences of n cyclic electrochemical test cycles.
